(19) United States
(12) Patent Application Publication
(10) Pub. No.: US 2009/0012854 A1
(43) Pub. Date: Jan. 8, 2009

(54) FLEXIBLE, DYNAMIC DESIGN TO ALLOW FOR FIXED AND PERCENTAGE DISCOUNT PRICING AT CONFIGURABLE OPTION LEVELS

(75) Inventors: Brad M. Altice, Wake Forest, NC (US); Felix E. Bonet, Apex, NC (US); Alphana B. Hobbs, II, Durham, NC (US); Gouri Mantena, Cary, NC (US); William J. Reilly, Cary, NC (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/773,477

(22) Filed: Jul. 5, 2007

(51) Int. Cl. G06Q 10/00

(52) U.S. Cl. 705/14

(57) ABSTRACT

A method and system are disclosed for enabling fixed and percentage discount pricing at configuration option level, when a configurable product is ordered. The method comprises the steps of creating a condition table having information used to determine both fixed and percentage discount pricing. A Contract is also provided having information used to determine those discounts. When a product is ordered against the Contract, information from both the Contract and the condition table are used to determine the appropriate discount, if any, for each selected option item. The appropriate discount may be a fixed price discount, or a percentage discount based on the list price for the option.

### BACKGROUND OF THE INVENTION

1. Field of the Invention

The present invention generally relates to methods and systems for pricing configurable products. More specifically, the invention relates to such methods and systems that allow fixed and percentage discount pricing at configurable option levels.

2. Background Art

Many products available today are configurable by the customer. In general terms, this means that the product has a number of attributes for which various options are available. Personal computers are an example of a configurable product. For example, a customer may be allowed to specify a variety of options relating to attributes such as the type of processor, memory, storage devices, and peripherals. Electrical connectors are another example of a configurable product. For example, a customer may specify options relating to attributes such as gender (e.g. plug vs. receptacle), termination (e.g. cable vs. circuit board, straight vs. right angle), and numbers of signal lines and coaxial lines.

One problem with the sale of configurable products is that there is no support for allowing a configurable product to have selectable options allowing both percentage discounting and fixed pricing discounting. There is support with ERP systems, and mainly SAP, to allow for either fixed pricing or percentage discounting at the selectable option level. But the flexibility of allowing both types of discount pricing is required for marketing opportunities, flexible pricing options, and the ability to offer special incentive possibilities.

### SUMMARY OF THE INVENTION

An object of this invention is to provide a process and design to allow for full selectable option pricing for a configurable product.

Another object of the present invention is to give the flexibility to have fixed price discounting and percentage discount pricing at the component (option) level for a configurable product.

These and other objectives are attained with a method and system of enabling fixed and percentage discount pricing at configuration option level, when a configurable product is ordered. The method comprises the steps of creating a condition table having information used to determine both fixed and percentage discount pricing. A Contract is also provided having information used to determine those discounts. When a product is ordered against the Contract, information from both the Contract and the condition table are used to determine the appropriate discount, if any, for each selected option item. The appropriate discount may be a fixed price discount, or a percentage discount based on the list price for the option.

The preferred embodiment of this invention, described below in detail, provides a process and design to allow for full selectable option pricing. The design gives the flexibility to have fixed price discounting and percentage discount pricing at the component (option) level for a configurable product. Current designs allow for fixed discount pricing for all selectable components or percentage discounting for all selectable components, but not both for a single line item. For example, SAP allows for fixed pricing or percentage discounts at a component level within a line item but not the combination of both.

Below is an Example Order line item with four selectable components, each of which is priced individually and with fixed and percentage discount pricing:

### Configurable Material

| | | |
|---|---|---|
| Component 1 | 100 | fixed price |
| Component 2 | 100 | fixed price |
| Fixed price total | 200 | |
| Component 3 | 200 | List price |
| Component 4 | 200 | List price |
| List price total | 400 | |
| Percentage discount = 10% | | |
| Fixed price total | 200 | |
| List price total 400 − 10% = | 360 | |
| Total Entitled price = | 560 | (This is the price the specific |
| | | customer is ‘entitled’ to). |

The advantages of offering such a design include:
1. Flexibility for the Marketing organization to offer different incentives for different products and customers.
2. Dynamic and flexible pricing options to protect minimum pricing/cost requirements of certain options, while allowing percentage discounts for other more profitable options.
3. Allows for discrete pricing and quotations of additional selectable options.
4. Gives the customer specific prices for web ordering views.
5. Protects required minimums for Royalty payments to third party vendors, such as third party software (e.g. Windows Operating Systems).
6. Can ran different promotions for similar/competing components by offering fixed pricing on certain components versus others with customer specific percentage discounts.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a flow chart that shows a preferred procedure for implementing the present invention.

FIG. 2 is a fixed price condition table for a particular contract and material used in the procedure of FIG. 1.

FIG. 3 illustrates an example order with new pricing condition ZFOO to support flexible pricing process.

FIG. 4 depicts a computer system that may be used to practice this invention.

### DETAILED DESCRIPTION OF THE PREFERRED EMBODIMENTS

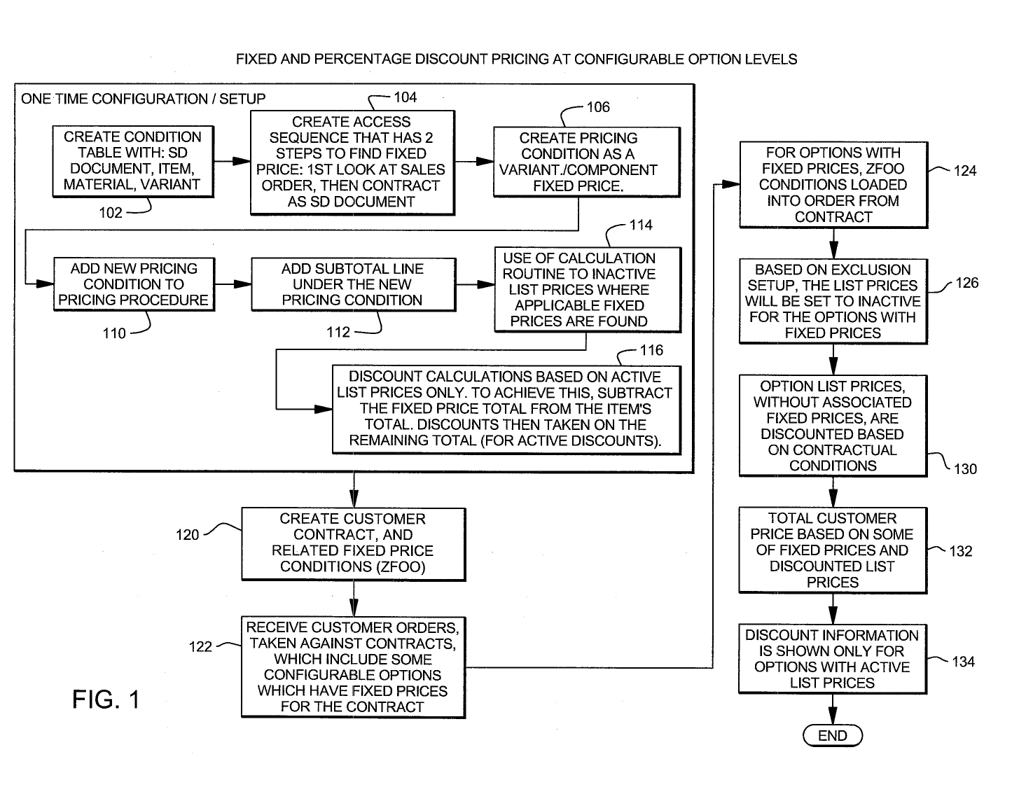

The present invention provides a method and system that allows both fixed and percentage discount pricing at configurable option levels. FIG. 1 shows a preferred procedure for implementing this invention.

In this process, step 102 is to create a table with: Condition type, SD document, Item, Material, Variant. Step 104 is to create access sequence that has Contract and Sales order as SD document. Step 106 is to create pricing condition as a variant/component fixed price. The condition is to be set up as a contract price agreement. Step 110 is to add new pricing condition to pricing procedure, and step 112 is to add Subtotal line under the new pricing condition.

Step 114 is to achieve exclusion of specific component list price through the calculation routine of the variant/component list price. This will exclude or make inactive only the variants/components where a variant/component fixed price is found. SAP standard exclusion configuration cannot be used, as it would have all list prices excluded when any new pricing condition was found for the line item. The use of the calculation routine is key to ensure that only a specific variant/component is marked inactive.

As represented at step 116, discount calculations should be based on the active list prices when a fixed price discount condition is applied. The fixed price discounts should not be taken into account when calculating the discounted price. To achieve this, subtract the fixed price discount total from the item's running total. Given any discounts, this will calculate the correct amount—taking into account active list price conditions. This is done in for all discounts. The running total will not take into account the fixed price subtotal.

The subtotal is used to work together with another condition, which is the line item's quoted price. This ensures that the quoted price is met up to the subtotal of the fixed price for the components. This allows discounting but only for those components with a regular percentage discount not the fixed price discount.

Ensure pricing date of all new pricing conditions is set to order document date. This locks the order fixed prices at order create. Ensure that exchange date is also locked at order create.

Update the Component level entitled price and discount calculated conditions that show the end result of discounts at the component level. Condition ZA03 (showing the discounted price) should be set equal to the new pricing condition value if any exist as this will be the entitled price for this component and no further discount will be given. Condition ZA04 (showing the discount off the list price) in this case shall be set to 0 as the new ZFOO pricing condition value is a fixed price override and not a discount.

Also the total value used to apportion the discount to all other components should not take into account the fixed price subtotal.

List Price total will not include the fixed price subtotal. The Entitled Price total will not include both the discounted list prices and the fixed prices.

As shown in FIG. 1, step 120 is to create customer contract and related fixed price conditions (ZFOO); and step 122 is to receive customer orders, taken against contracts, which include some configurable options which have fixed prices. ZFOO conditions are loaded into the order from the contract at step 124; and at step 126, based on exclusion setup, the list prices will be set to inactive for the options with fixed prices. At step 130, option list prices, without associated fixed prices, are discounted based on contracted conditions. At step 132, the total customer prices are based on the sum of fixed prices and discounted list prices; and, as represented at step 134, discount information is shown only for options with active list prices.

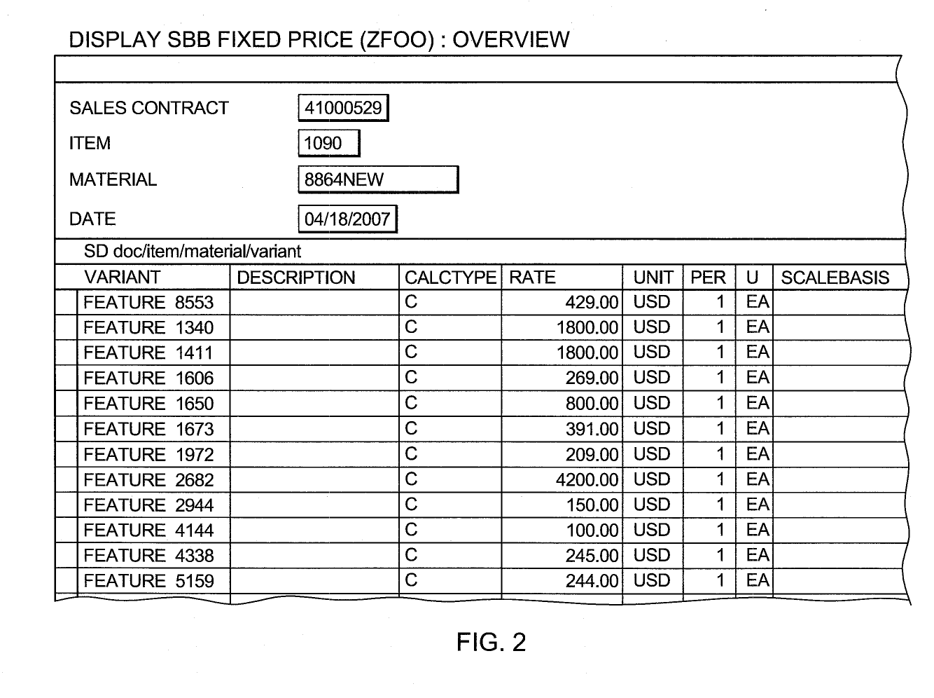

FIG. 2 shows an example of a fixed price condition table with example fixed prices loaded. Specifically, this table shows an example of ZFOO Fixed Pricing Conditions (against contract 41000529, item 1090, material 8864 new, with different options for that configurable material), which use the Fixed Pricing Condition Table.

Other programs impacted:
1. Ensure Mass update re-pricing tool works for the new pricing condition. This will be updated for multiple programs which are linked to the table, condition and the over all programs which run the pricing create based on a file; and
2. Ensure Contract Information Repository output is updated to send the new condition.

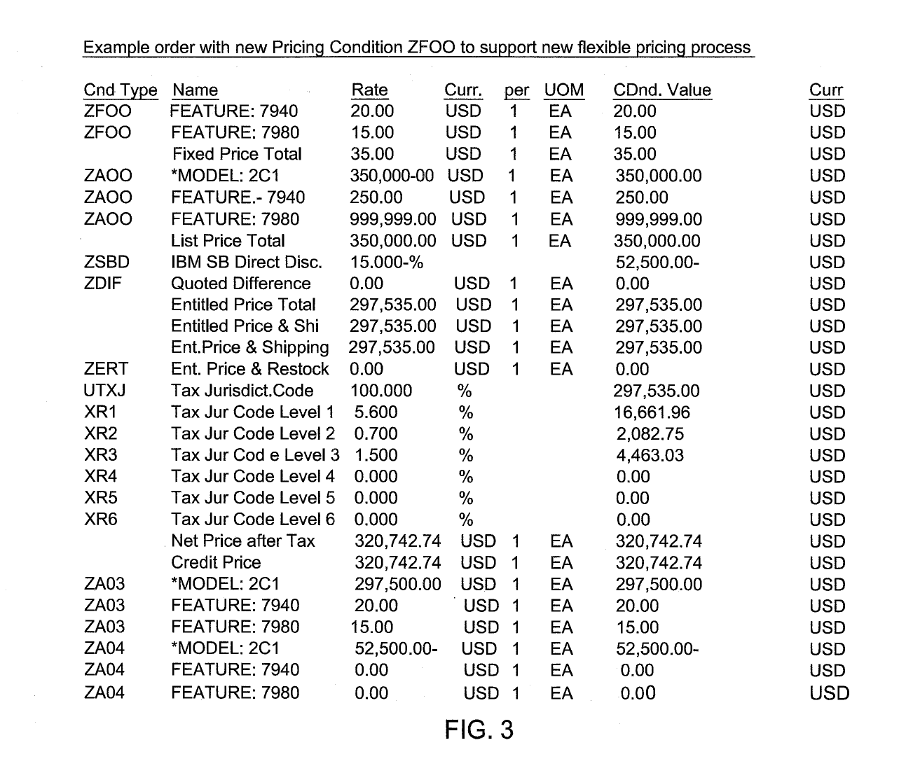

FIG. 3 shows an example order that may be used in the above-discussed procedure of the present invention. This order includes a number of columns including condition type, name, rate and condition value.

As will be readily apparent to those skilled in the art, the present invention, or aspects of the invention, can be realized in hardware, software, or a combination of hardware and software. Any kind of computer/server system(s)—or other apparatus adapted for carrying out methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

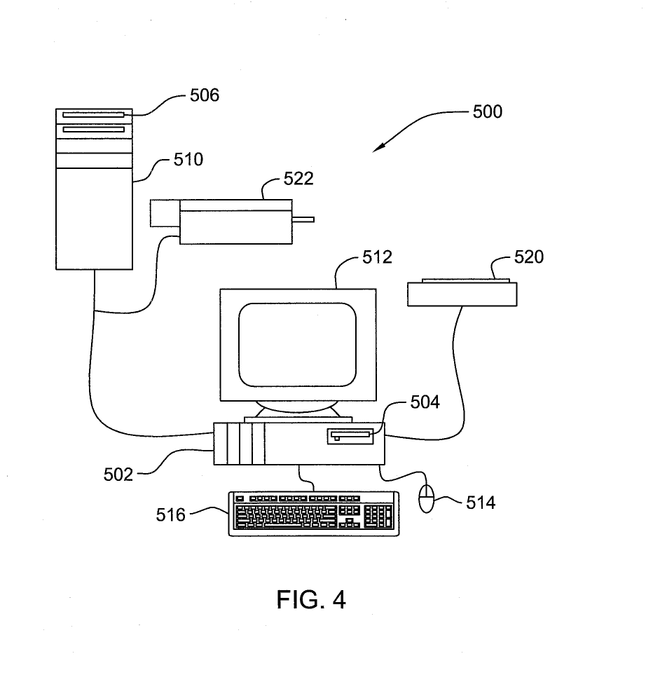

For example, FIG. 4 illustrates a computer system 400 which may be used in the implementation of the present invention may be carried out. Computer system includes a processing unit 402 that houses a processor, memory and other systems components that implement a general purpose processing system that may execute a computer program product comprising media, for example a floppy disc that may be read by processing unit 402 through floppy drive 404.

The program product may also be stored on hard disk drives within processing unit 402 or may be located on a remote system 406 such as a server 410, coupled to processing unit 402, via a network interface, such as an Ethernet interface. Monitor 412, mouse 414 and keyboard 416 are coupled to processing unit 402, to provide user interaction. Scanner 420 and printer 422 are provided for document input and output. Printer 422 is shown coupled to processing unit 402 via a network connection, but may be coupled directly to the processing unit. Scanner 420 is shown coupled to processing unit 402 directly, but it should be understood that peripherals might be network coupled or direct coupled without affecting the ability of workstation computer 400 to perform the method of, or aspects of, the invention.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of enabling both fixed and percentage discount pricing at configuration option level when a configurable product is ordered, the method comprising the steps of:
creating a condition table for the configurable product, said table identifying a multitude of options for the product, and including a plurality of columns including an SD document column, an item column, a material column and a variant column;
creating an access sequence to find a fixed price discount, including the steps of first looking at a sales order, and then looking at a Contract as an SD document;
creating a new pricing condition as a variant/component fixed price discount;
adding said new pricing condition to a pricing procedure;
adding to the table a subtotal line under the new pricing condition;
using a calculation routine to inactive list prices where applicable fixed price discounts are found;
performing a discount calculation based on active list prices only;
creating a customer contract and related fixed price discount conditions;
receiving a customer order for the configurable product, said customer order being taken against a defined customer contract, said customer contract including some configurable options that have fixed prices for the contract;
for configurable options with fixed price discounts, loading fixed price discount conditions into the customer order from the customer contract;
based on an exclusion setup, setting the list prices to inactive for the options with fixed price discounts;
discounting option list prices, without associated fixed price discounts, based on conditions of the customer contract; and
determining total customer price based on a sum of fixed price discounts and discounted list prices.

2. A method according to claim 1, wherein the step of performing a discount calculation includes the steps of:
subtracting a fixed price discount total from the item's total; and
then taking discounts on the remaining total.

3. A method according to claim 2, comprising the further step of showing discount information only for option with active list prices.

4. A method according to claim 3, wherein the step of creating a new pricing condition includes the step of creating the new pricing condition as a contract price agreement.
